(19) United States
(12) Patent Application Publication
(10) Pub. No.: US 2006/0028966 A1
(43) Pub. Date: Feb. 9, 2006

(54) Braille atomic storage at room temperature and open air

(76) Inventor: Harold Szu, Potomac, MD (US)

Correspondence Address: IP STRATEGIES, 12 1/2 WALL STREET, SUITE I, ASHEVILLE, NC, 28801, US

(21) Appl. No.: 11/198,876

(22) Filed: Aug. 4, 2005

Related U.S. Application Data
(60) Provisional application No. 60/598,993, filed on Aug. 4, 2004.

(51) Int. Cl. G11B 9/00

(52) U.S. Cl. 369/126

(57) ABSTRACT

A process of providing storage for data on a storage medium includes precisely placing an atom onto a surface of the storage medium as an interstitial impurity, and moving the atom to a specific storage site on the storage medium as a stored bit of data. A storage medium includes a surface, an atom that is precisely inserted onto the surface as an interstitial impurity, and a write device that moves the atom to a specific storage site on the surface as a stored bit of data.

### CROSS-REFERENCE TO RELATED APPLICATION

This is related to and claims priority from U.S. Provisional Patent Application No. 60/598,993, which was filed on Aug. 4, 2004, the entirety of which is incorporated herein.

### FIELD OF THE INVENTION

The present invention relates to methods of storing data, and to data storage apparatus.

### BACKGROUND OF THE INVENTION

The 19^{th} Century French scientist Dr. Braille invented raised dots and Braille symbols for blind people to read by touching. Similar raised dots have been used as read-and-writable “atomic bits” on a crystal surface by an Atomic Force Microscope (AFM), and for manipulation of a strong Carbon-Nano-Tube (CNT) Cantilever, for example, by using an AFM tip as an end effector.

It has also been demonstrated that, by pushing 100 nm latex particles on a glass surface, read-write operations can be performed in which a single crystal CNT cantilever provides a strong contact mode operation of AFM, and therefore in principle can move atoms around under computer control. In addition, contact mode operation for pushing gold particles (50 nm) on SiO₂ surface (1 μm) has been demonstrated.

AFMs use feedback to regulate the force on the sample. A compensation network, for example, a computer program, monitors the cantilever deflection and keeps it constant by adjusting the height of the sample (or cantilever).

The presence of a feedback loop is one of the subtler differences between AFMs and older stylus-based instruments such as record players and stylus profilometers. The AFM not only measures the force on the sample but also regulates it, allowing acquisition of images at very low forces.

The feedback loop consists of the tube scanner that controls the height of the entire sample; the cantilever and optical lever, which measures the local height of the sample; and a feedback circuit that attempts to keep the cantilever deflection constant by adjusting the voltage applied to the scanner.

One point of interest: the faster the feedback loop can correct deviations of the cantilever deflection, the faster the AFM can acquire images. Therefore, a well-constructed feedback loop is an important factor affecting microscope performance. AFM feedback loops tend to have a bandwidth of about 10 kHz, resulting in image acquisition times of about one minute.

Almost all AFMs can measure sample topography in either of two ways: by recording the feedback output (“Z”) or the cantilever deflection (“error”). The sum of these two signals always yields the actual topography, but given a well-adjusted feedback loop, the error signal should be negligible. As described below, AFMs may have alternative imaging modes in addition to these standard modes.

If the scanner moves the sample perpendicular to the long axis of the cantilever, friction between the tip and sample causes the cantilever to twist. A photodetector position-sensitive in two dimensions can distinguish the resulting left-and-right motion of the reflected laser beam from the up-and-down motion caused by topographic variations.

Therefore, AFMs can measure tip-sample friction while imaging sample topography. Besides serving as an indicator of sample properties, friction (or “lateral force,” or “lateral deflection”) measurements provide valuable information about the tip-sample interaction.

The scanning tunneling microscope (STM) and atomic force microscope provide pictures of atoms on or in surfaces. A system that uses variations of the principles used by an STM or AFM to image surfaces is often called a scanning probe microscope (SPM).

The AFM works by scanning a fine ceramic or semiconductor tip over a surface much the same way as a phonograph needle scans a record. The tip is positioned at the end of a cantilever beam shaped much like a diving board. As the tip is repelled by or attracted to the surface, the cantilever beam deflects. The magnitude of the deflection is captured by a laser that reflects at an oblique angle from the very end of the cantilever. A plot of the laser deflection versus tip position on the sample surface provides the resolution of the hills and valleys that constitute the topography of the surface. The AFM can work with the tip touching the sample (contact mode), or the tip can tap across the surface (tapping mode) much like the cane of a blind person.

Piezoelectric ceramics are a class of materials that expand or contract when in the presence of a voltage gradient or, conversely, create a voltage gradient when forced to expand or contract. Piezoceramics make it possible to create three-dimensional positioning devices of arbitrarily high precision. Most scanned-probe microscopes use tube-shaped piezoceramics because they combine a simple one-piece construction with high stability and large scan range. Four electrodes cover the outer surface of the tube, while a single electrode covers the inner surface. Application of voltages to one or more of the electrodes causes the tube to bend or stretch, moving the sample in three dimensions.

Other measurements can be made using modifications of the SPM. These include variations in surface microfriction with a lateral force microscope (LFM), orientation of magnetic domains with a magnetic force microscope (MFM), and differences in elastic modulii on the micro-scale with a force modulation microscope (FMM). A very recent adaptation of the SPM has been developed to probe differences in chemical forces across a surface at the molecular scale. This technique has been called the chemical force microscope (CFM). The AFM and STM can also be used to do electrochemistry on the microscale.

AFM is being used to solve processing and materials problems in a wide range of technologies affecting the electronics, telecommunications, biological, chemical, automotive, aerospace, and energy industries. The materials being investigating include thin and thick film coatings, ceramics, composites, glasses, synthetic and biological membranes, metals, polymers, and semiconductors. The AFM is being applied to studies of phenomena such as abrasion, adhesion, cleaning, corrosion, etching, friction, lubrication, plating, and polishing. The publications related to the AFM are growing rapidly since its introduction.

The first AFM used a scanning tunneling microscope at the end of the cantilever to detect the bending of the lever, but now most AFMs employ an optical lever technique.

The diagram illustrates how this works; as the cantilever flexes, the light from the laser is reflected onto the split photo-diode. By measuring the difference signal (A-B), changes in the bending of the cantilever can be measured. Because the cantilever obeys Hooke's Law for small displacements, the interaction force between the tip and the sample can be found.

The movement of the tip or sample is performed by an extremely precise positioning device made from piezo-electric ceramics, most often in the form of a tube scanner. The scanner is capable of sub-angstrom resolution in x-, y- and z-directions. The z-axis is conventionally perpendicular to the sample.

The AFM can be operated in two principal modes: with feedback control or without feedback control.

If the electronic feedback is switched on, then the positioning piezo which is moving the sample (or tip) up and down can respond to any changes in force that are detected, and alter the tip-sample separation to restore the force to a pre-determined value. This mode of operation is known as constant force, and usually enables a fairly faithful topographical image to be obtained (hence the alternative name, height mode).

If the feedback electronics are switched off, then the microscope is said to be operating in constant height or deflection mode. This is particularly useful for imaging very flat samples at high resolution. Often it is best to have a small amount of feedback-loop gain, to avoid problems with thermal drift or the possibility of a rough sample's damaging the tip and/or cantilever. Strictly, this should then be called error signal mode.

The error signal mode can also be displayed while feedback is switched on; this image will remove slow variations in topography but highlight the edges of features.

The way in which image contrast is obtained can be achieved in many ways. The three main classes of interaction are contact mode, tapping mode and non-contact mode. Contact mode is the most common method of operation of the AFM. As the name suggests, the tip and sample remain in close contact as the scanning proceeds. In this context, “contact” means in the repulsive regime of the inter-molecular force curve. The repulsive region of the curve lies above the x-axis. One of the drawbacks of remaining in contact with the sample is that there exist large lateral forces on the sample as the drip is “dragged” over the specimen.

Tapping mode is the next most common mode used in AFM. When operated in air or other gases, the cantilever is oscillated at its resonant frequency (often hundreds of kilohertz) and positioned above the surface so that it only taps the surface for a very small fraction of its oscillation period. This is still contact with the sample in the sense defined earlier, but the very short time over which this contact occurs means that lateral forces are dramatically reduced as the tip scans over the surface. When imaging poorly immobilized or soft samples, tapping mode might be a far better choice than contact mode for imaging.

Other (more interesting) methods of obtaining image contrast are also possible with tapping mode. In constant force mode, the feedback loop adjusts so that the amplitude of the cantilever oscillation remains (nearly) constant. An image can be formed from this amplitude signal, as there will be small variations in this oscillation amplitude due to the control electronics' not responding instantaneously to changes on the specimen surface.

More recently, there has been much interest in phase imaging. This works by measuring the phase difference between the oscillations of the cantilever-driving piezo and the detected oscillations. It is thought that image contrast is derived from image properties such as stiffness and viscoelasticiy.

Non-contact operation is another method that can be employed when imaging by AFM. The cantilever must be oscillated above the surface of the sample at such a distance that it is no longer in the repulsive regime of the inter-molecular force curve. This is a very difficult mode to operate in ambient conditions with the AFM. The thin layer of water contamination that exists on the surface on the sample will invariably form a small capillary bridge between the tip and the sample and cause the tip to “jump-to-contact”.

Several techniques in AFM rely on removing topographical information from some other signal. Magnetic force imaging and electrostatic force imaging work by first determining the topography along a scan line, and then lifting a pre-determined distance above the surface to re-trace the line following the contour of the surface. In this way, the tip-sample distance should be unaffected by topography, and an image can be built up by recording changes that occur due to longer range force interactions, such as magnetic forces.

Height image data obtained by the AFM is three-dimensional. The usual method for displaying the data is to use color mapping for height, for example, black for low features and white for high features. Similar color mappings can be used for non-topographical information such as phase or potential.

One of the most important factors influencing the resolution that can be achieved with an AFM is the sharpness of the scanning tip. The first tips used by the inventors of the AFM were made by gluing diamond onto pieces of aluminum foil. Commercially fabricated probes are now universally used. The best tips sometimes have a radius of curvature of only around 5 nm. The need for sharp tips is normally explained in terms of tip convolution. This term is often used (slightly incorrectly) to group together any influence that the tip has on the image. The main influences are broadening, compression, interaction forces, and aspect ratio.

Tip broadening arises when the radius of curvature of the tip is comparable with, or greater than, the size of the feature trying to be imaged. As the tip scans over the specimen, the sides of the tip make contact before the apex, and the microscope begins to respond to the feature. This is called tip convolution.

Compression occurs when the tip is disposed over the feature trying to be imaged. It is difficult to determine in many cases how important this effect is, but studies on some soft biological polymers (such as DNA) have shown the apparent DNA width to be a function of imaging force. It should be borne in mind that although the force between the tip and sample might only be nN, the pressure may be MPa. Interaction forces between the tip and sample are the reason for image contrast with the AFM. However, some changes that might be perceived as being topographical, might actually be due to a change in force interaction. Forces due to the chemical nature of the tip are probably most important here, and selection of a particular tip for its material can be important. Chemical mapping using specially treated or modified tips is another important aspect of current research in SPM.

The aspect ratio (or cone angle) of a particular tip is crucial when imaging steep sloped features. Electron beam deposited tips have been used to image steep-walled features far more faithfully than can be achieved with the common pyramidal tips. This effect has been shown very clearly in experiments on the degradation of starch granules by enzymes in the AFM.

Most users purchase AFM cantilevers with their attached tips from commercial vendors, who manufacture the tips with a variety of microlithographic techniques. A close enough inspection of any AFM tip reveals that it is rounded off. Therefore, force microscopists generally evaluate tips by determining their “end radius.” In combination with tip-sample interaction effects, this end radius generally limits the resolution of an AFM. As such, the development of sharper tips is currently an issue. Force microscopists generally use one of three types of tip. The “normal tip” is a 3 μm tall pyramid with ˜30 nm end radius. The electron-beam-deposited (EBD) tip or “supertip” improves on this with an electron-beam-induced deposit of carbonaceous material made by pointing a normal tip straight into the electron beam of a scanning electron microscope. Especially if the user first contaminates the cantilever with paraffin oil, a supertip will form upon stopping the raster of the electron beam at the apex of the tip for several minutes. The supertip offers a higher aspect ratio (it is long and thin, good for probing pits and crevices) and sometimes a better end radius than the normal tip. In addition, Park Scientific Instruments offers the “Ultralever”, based on an improved microlithography process. Ultralevers offers a moderately high aspect ratio and on occasion a ˜10 nm end radius. Tube piezoceramics position the tip or sample with high resolution.

Carbon nanotubes possess many unique properties that make them ideal AFM probes. Their high aspect ratio provides faithful imaging of deep trenches, while good resolution is retained due to their nanometer-scale diameter. These geometrical factors also lead to reduced tip-sample adhesion, which allows gentler imaging. Nanotubes elastically buckle rather than break when deformed, which results in highly robust probes. They are electrically conductive, which allows their use in STM and EFM (electric force microscopy), and they can be modified at their ends with specific chemical or biological groups for high resolution functional imaging.

All of the properties mentioned above have been exhibited with tips fabricated by manual assembly: pre-formed nanotube material and commercial AFM tips are connected to micromanipulators and the nanotubes are attached to the tip while viewed with an optical microscope. Although this procedure has enjoyed success in the initial development of nanotube tips, it is ultimately limited for several reasons. First, the procedure is laborious and only produces one tip at a time, so it is unlikely that nanotube tips produced this way will be made widely available. Second, viewing with an optical microscope selects towards large diameter nanotube bundles, which have lower resolution than thin, individual nanotube tips. Finally, there is currently no manual assembly technique or tip etching method that will produce an individual single-walled nanotube tip at the very end. This is significant because these nanotubes, with 1-2 nm diameters, could provide unprecedented resolution on individual biomolecules.

Direct growth of nanotubes on standard Si AFM tips by chemical vapor deposition will solve the shortcomings of the manual assembly method. CVD can be carried out at the wafer level of tip fabrication, allowing mass production of nanotube tips. Also, recent reports have demonstrated that 1-5 nm diameter single-walled nanotubes can be produced by CVD at temperatures compatible with silicon tips, so CVD can produce very high resolution tips.

CVD have been produced nanotube tips by two methods. In the first, referred to as “pore growth”, a flat 1-5 square micron area is created on a silcon AFM tip. The tip is anodized in HF to create 100 nm diameter, 1 micron deep pores. Iron is then deposited in these pores electrochemically, or preformed iron oxide catalyst particles are deposited in the pores. CVD is carried out in a tube furnace at 800 C with an argon, hydrogen, ethylene mixture known to favor the growth of thin nanotubes. Nanotube diameter can be controlled by using well defined iron colloids as catalyst.

The second CVD nanotube tip fabrication technique, referred to herein as “surface growth”, has a much simpler tip preparation procedure. Using a supported catalyst that is a mixture of alumina, iron, and molybdenum particles and is known to produce multi-wall or single-walled nanotubes depending on growth conditions, the powdered catalyst is sonicated in ethanol to create a colloidal suspension of alumina supported Fe/Mo particles. Silicon AFM tips are dipped into this colloidal suspension, and catalyst particles stick to its surface. These tips are then heated in an argon, hydrogen, ethylene mixture at 800° C. under conditions known to produce thin nanotubes from this catalyst. The nanotubes grow along the surface of the pyramidal silicon tip. When they reach an edge, they will bend to stay in contact with the silicon rather than protrude from the edge. In this way, nanotubes are guided towards the tip apex. At the apex, the strain energy would be too great to bend through such a small radius of curvature, so they protrude from the tip. Occasionally nanotubes protrude from the pyramid edges as well, but nanotubes protrude from the tip too frequently to be explained by chance, so the “surface growth” mechanism described above must be in effect.

It would be advantageous to provide external means to facilitate write-by-contact mode of an AFM of an atomic bit, one among zeros, and storing it by interstitial atomic force for room temperature stability, a nondestructive read process by AFM imaging mode, and a data erase by external means. It would be beneficial to refine these processes for a real-time portable device.

### BRIEF DESCRIPTION OF THE INVENTION

The present invention provides massive atomic storage, preferably at an Angstrom scale in open air at room temperature. The present invention can be embodied as a real-time portable device, in contrast to early attempts at providing massive optical storage through “spectrum hole-burning”, which operated inconveniently at cryogenic low temperatures. Thus, the Braille atomic storage concept is extended to the crystalline atomic level in open air and room temperature.

According to an aspect of the invention, a process of providing storage for data on a storage medium includes precisely inserting an atom onto a surface of the storage medium as an interstitial impurity, and moving the atom to a specific storage site on the storage medium as a stored bit of data. The specific storage site can represent an address on the surface of the storage medium. The storage medium can be disposed in open air. The storage medium can be disposed at room temperature. The atom preferably has a size that is on the order of an angstrom, and can represent a “1” data bit. Likewise, at least one other specific storage site can be present on the surface of the storage medium that does not store an atom as an interstitial impurity and that represents a “0” data bit.

Moving the atom to a specific storage site can include moving the atom by adaptive control, which in turn includes moving the atom using a cantilever of an atomic force microscope. For example, the cantilever can be a single-crystal carbon nanotube tip. The atomic force microscope can be used in contact mode operation. The cantilever can be used to overcome a potential barrier at the specific storage site. The cantilever can be used under computer feedback control.

The surface of the storage medium can have a regular lattice structure. For example, the surface of the storage medium can includes any one or more of a solid, plasma, and liquid crystal. The surface of the storage medium can have a size ranging from about the order of a nanometer to about the order of a centimeter. The surface of the storage medium can be arranged as a plurality of specific storage sites, which in turn can be arranged as an array. Each of the plurality of specific storage sites can be separated from an adjacent specific storage site by a distance on the order of ten angstroms. The storage medium can be a body center crystal.

According to another aspect of the invention, a storage medium includes a surface, an atom that is precisely inserted onto the surface as an interstitial impurity, and a write device that moves the atom to a specific storage site on the surface as a stored bit of data. For example, the specific storage site can represent an address on the surface of the storage medium. The storage medium can be disposed in open air. The storage medium can be disposed at room temperature. Preferably, the atom has a size that is on the order of an angstrom. The stored atom can represent a “1” data bit. Likewise, at least one other specific storage site can exist on the surface of the storage medium that does not store an atom as an interstitial impurity, which can represent a “0” data bit.

The write device can move the atom to a specific storage site by adaptive control. For example, the write device can include a cantilever of an atomic force microscope, such as a single-crystal carbon nanotube tip. The atomic force microscope can be set up for contact mode operation. The cantilever can provide force to overcome a potential barrier at the specific storage site. The cantilever can be adapted for communication with a computer for use under computer feedback control.

The surface of the storage medium can have a regular lattice structure, and can include any one or more of a solid, plasma, and liquid crystal. The surface of the storage medium can have a size ranging from about the order of a nanometer to about the order of a centimeter. The surface of the storage medium can be arranged as a plurality of specific storage sites. For example, the plurality of specific storage sites can be arranged as an array. Each of the plurality of specific storage sites can be separated from an adjacent specific storage site by a distance on the order of ten angstroms. The storage medium can include a body center crystal.

Thus, an inert atom or a charged atom can be inserted precisely in an energy-favorably fashion at the surface of a storage medium as an interstitial impurity, taking advantage of properties of the Einstein fluctuation and dissipation theorem, due to e thermal fluctuation of specific inert and neutral atomic charge distribution with respect to mirror plan geometry in the reduction of permissible vacuum fluctuations, Casimir force, or induced magnetic dipole long range London force or van der Waals attraction force, existed appreciably only at an atomic scale.

The read-write system utilizes inert or charged “atomic bits” that can be selectively moved by means of adaptive control of a single-crystal strong carbon nanotube tip used as the cantilever of a reading atomic force microscope in contact mode operation toward a specific storage site. It is possible to use this apparatus to apply an electromagnetic pondermotive force to facilitate the initial write stage because a surrounding potential barrier can be overcome by a strong single-crystal carbon nanotube tip cantilever, preferably utilized under computer feedback control.

The information science concept in terms of elementary “atomic bits” at a few angstrom diameters, used for binary storage, is realized, for example, by setting a “1” for an impurity atom and a “0” for a regular lattice space to provide massively parallel read/write capability on any type of medium, including solid, plasma, or liquid crystal, or a sheet ranging in scale from millimeter to micron to nano size.

### BRIEF DESCRIPTION OF THE DRAWINGS

FIG. 1 is a diagram illustrating optical reading of an object using an AFM.

FIG. 2 is a diagram illustrating operation of an optical lever by reflecting a laser beam off the cantilever.

FIG. 3 is an illustration of an exemplary topographic imaging set-up

FIG. 4 is an illustration of an exemplary atomic force microscopy set-up.

FIG. 5 is an illustration of an exemplary friction force microscopy set-up.

FIG. 6 shows a simultaneous friction and topography image of graphite atoms.

FIG. 7 is a sawtooth waveform of the friction image of FIG. 6.

FIG. 8 is a graph of force curves showing cantilever deflection due to meniscus force.

### DETAILED DESCRIPTION OF THE INVENTION

As stated above, the present invention provides massive atomic storage, preferably at an angstrom scale in open air at room temperature. The present invention can be embodied as a real-time portable device, in contrast to early attempts at providing massive optical storage through “spectrum hole-burning”, which operated inconveniently at cryogenic low temperatures. Thus, the Braille atomic storage concept is extended to the crystalline atomic level in open air and room temperature.

A disadvantage of working at room temperature is the thermal noise fluctuation. On the other hand, the equal partition law of each degree of freedom of atomic bits provides at room temperature thermal energy:

Thermal energy KT room temperature=( 1/40)=0.025 eV (cf. van der Waal 0.2 eV; metallic 2 eV ionic or covalent 2-10 eV; semi-conductor gap 1 eV, insulator 5-10 e).

Einstein's fluctuation and dissipation theorem regarding Brownian diffusion D=KT/η to be inversely proportional to the viscosity; this has also been shown in a dynamic version.
<F(xt)F(x′t′)>=2KT f δ(x−x′)δ(t−t′)
where the Boltzmann constant K and Kelvin temperature T are due to e thermal fluctuation of specific inert and neutral atomic charge distribution with respect to the mirror plan geometry and friction f.

Another factor is that impurity of the crystalline structure that is relevant to storage stability at room temperature. The relaxation dynamics of impurity vibrations have been studied down to the picosecond timescale resolution. Such studies are only now becoming possible because of improvements in ultrafast infrared (IR) laser technology, which allow lifetime measurements to be performed in the time domain. This technology will provide a better understanding of the vibrational dynamics and pathways of energy transfer at impurity sites. In particular, vibrational relaxation should affect the reactivity of impurities and their diffusion and desorption rates. This information is of interest to the semiconductor industry because it describes the durability of wafers made of silicon (Si), gallium arsenide (GaAs), and germanium (Ge) when carrying electric current. Defects in these crystals, such as lattice vacancies and interstitials, as well as impurities such as hydrogen (H), oxygen (O), carbon (C), and nitrogen (N), greatly alter their electrical properties. These impurities, which are lighter than the host-lattice atoms, give rise to local vibrational modes (LVMs) with frequencies above the phonon bands of the crystal. Depending on the details of the lattice location of the defect or impurity atom, particularly regarding symmetry and how many bonds are formed with host lattice atoms, one observes a number of normal vibrational modes with well-defined frequencies. Measuring the lifetime of the first excited states of the local vibrational modes elucidates these defect properties.

The system of the present invention includes writing the “atomic bits” at few Angstrom diameter size with the help of external light and electromagnetic ponderomotive force, in order to selectively move the atomic bits by means of the contact mode operation of a CNT tip cantilever of an AFM at a specific storage medium, for example, a 1 cm×1 cm body center cubic (BCC) crystal surface at ten angstrom unit lattice spacing. This is energetically possible because a surrounding potential barrier can be temporally altered by the external means due to the specific mirror reflection geometry reduction of permissible vacuum fluctuations, Casimir force, or induced magnetic dipole long-range van der Waals attraction force. To manipulate light beams at that scale, it is advantageous to use tiny mirrors that can pivot to reflect photons down different channels. Use of the Casimir force, which essentially deals with photons' ability to move small objects, facilitates moving the mirrors with precision. The cantilever CNT tip making contact with an obstacle on the surface can generate a stress-induced potential that is restored back to the norm by a read-out delta changed point-by-point as a magnified TV image. Utilizing the active inverse operation, called nano-manipulator controlled by PC, a nano-robot-arm can push an atom over a (van der Waals potential) barrier for nano-fabrication applications.

Quoting Larmoureaux, who had measured in 1997 the Casimir force: “In 1948 Dutch physicist Hendrik B. G. Casimir of Philips Research Labs predicted that two uncharged parallel metal plates will have an attractive force pressing them together. This force is only measurable when the distance between the two plates is extremely small, on the order of several atomic diameters. This attraction is called the Casimir effect. The Casimir effect is caused by the fact that space is filled with vacuum fluctuations, virtual particle-antiparticle pairs and photons that continually form out of nothing and then vanish back into nothing an instant later. The gap between the two plates restricts the range of wavelengths possible for these virtual photons, and so fewer virtual modes exist within this space. This results in a lower energy density between the two plates than is present in open space; in essence, the vacuum energy density between the two plates is lower than outside, causing a force pushing the plates towards each other. The narrower the gap, the more restricted the vacuum modes and the smaller the vacuum energy density, and thus the stronger is the attractive force. Similarly, fluctuations in the electronic structure of molecules cause transient magnetic dipoles which lead to the Van der Waals force. The Casimir effect has recently been measured by Steve K. Lamoreaux of Los Alamos National Laboratory and by Umar Mohideen of the University of California at Riverside and his colleague Anushree Roy. The Casimir force per unit area F_{c}|A for idealized, perfectly conducting plates with vacuum between them is

$$\frac{{F}_{c}}{A} = \frac{ℏ c {π}^{2}}{240 {d}^{4}}$$

where
is Planck's constant divided by 2π,
c is the speed of light,
π is Archimedes's constant, the ratio of the circumference of a circle to its diameter, and
d is the distance between the two plates.
   This shows that the Casimir force per unit area F_{C}/A is very small. The calculation shows that the force happens to be proportional to the sum 1+2+3+4+5+ . . . where the numbers 1, 2, 3, 4, 5, . . . represent the frequencies of standing waves between the plates; each possible standing wave behaves as a quantum harmonic oscillator whose ground state energy equal to ω/2 contributes to the total potential energy; the force then equals minus the derivative of the potential energy with respect to the distance. The series (the sum of integers) is divergent and needs to be regularized. A useful tool is provided by the Riemann zeta function because the sum can be formally written as ζ(−1) which equals − 1/12. Although it may sound strange (and even though more rigorous ways to obtain the same result exist), the correct result for the sum of positive integers is − 1/12. The same sum also appears in string theory. It has since been shown that, with materials of certain permittivity and permeability, the Casimir effect can be repulsive instead of attractive.”

The atomic force microscope is one of about two dozen types of scanned-proximity probe microscopes. All of these microscopes work by measuring a local property, such as height, optical absorption, or magnetism—with a probe or “tip” placed very close to the sample. The small probe-sample separation (on the order of the instrument's resolution) makes it possible to take measurements over a small area. To acquire an image, the microscope raster-scans the probe over the sample while measuring the local property in question. The resulting image resembles an image on a television screen in that both consist of many rows or lines of information placed one above the other. Unlike traditional microscopes, scanned-probe systems do not use lenses, so the size of the probe rather than diffraction effects generally limits their resolution. The atomic force microscope measures topography with a force probe.

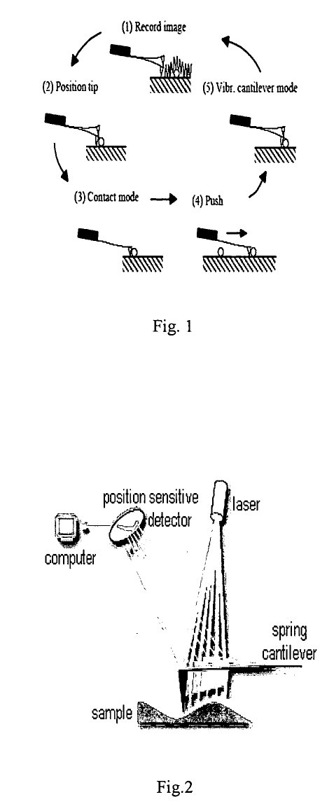

Thus, an AFM operates by measuring attractive or repulsive forces between a tip and the sample. As shown in FIG. 1, in its repulsive “contact” mode, the instrument lightly touches a tip at the end of a leaf spring or “cantilever” to the sample. As a raster-scan drags the tip over the sample, some sort of detection apparatus measures the vertical deflection of the cantilever, which indicates the local sample height. Thus, in contact mode the AFM measures hard-sphere repulsion forces between the tip and the sample.

Examining the history of single crystal super-structure and nanotechnology, a decade after Richard Feymann's famous statement about the existence of plenty of room in the microscopic atomic world, Leo Esaki and Ray Tsu built the first man-made superlattice quantum structure. The developments in the mid-1980's of scanning probe microscopes led, in 1986, to sub-angstrom resolution atomic imaging with an AFM operating in open air at room temperature. Since that time, totally new properties, properties that are radically different from those of natural atoms and molecules, have been discovered in tiny artificial objects. Such objects are now known as nano-systems, and include a plethora of new materials and devices, including fullerenes, hetero-structures, and the quantum Hall effect. Also, the world has witnessed the introduction of a number of technology-driven objects such as quantum wells, wires, dots, and anti-dots. The field is developing into a new area in engineering as the structure size of commercial products, such as computer chips, has continued to march towards the nano-regime. Interestingly, size alone is not enough, that is, not every object with dimensions about a billionth of a meter is a nano-system; rather, only those having properties that are determined by their size are considered to be nano-systems. Indeed, all neutral atoms are about half an angstrom, or one twentieth of a nanometer, in diameter. The diversity in atomic properties is not size related. Things are different in nano-systems and size is crucial; it is possible to adjust their dimensions, modify the boundary surfaces and interfaces, and distort the interactions, to push things into a frontier between atomic and bulk materials. In 1991, Iijima, while studying the carbonaceous deposit from an arc discharge between graphite electrodes, found highly crystallized carbon filaments that were merely a few nanometers in diameter and a few microns long. These high aspect ratio structures had a unique form: they contained carbon atoms arranged in graphene sheets, which were rolled together to form a seamless cylindrical tube, and each filament contained a ‘Russian doll’ arrangement of coaxial tubes. Hence, the term “nanotube” or “Nano carbon tubes (NCT)” was coined to describe these structures. An NCT can be single-walled (that is, one tube) or multi-walled (that is, multiple concentric tubes for varied thickness). NCT properties:
High aspect ratio structures with diameters in nanometers, lengths in microns
High mechanical strength (tensile strength 60 GPa) and modulus (Young's modulus 1 TPa)
High 1D electrical conductivity (10⁻⁶ ohm m typically), and for well-crystallized nanotubes, ballistic transport is observed
High 1D thermal conductivity (1750-5800 W/mK)
low thermal noise by equal partition law of 1D of freedom at ½ K_{B}T compared to 3/2 K_{B}T in regular Semi-conductor sensor band-gap material
Being covalently bonded, as electrical conductors they do not suffer from electromigration or atomic diffusion and thus can carry high current densities (10⁷-10⁹ A/cm²)
Single wall nanotubes can be metallic or semi-conducting
Chemically inert, not attacked by strong acids or alkali
Collectively, NCTs can provide extremely high surface areas for use as e-beam lithograph tips

Today, three main techniques are used to produce nanotubes, namely, electric arc discharge, laser ablation, and chemical vapour deposition. The arc discharge technique involves the generation of an electric arc between two graphite electrodes, one of which is usually filled with a catalyst metal powder (for example, iron, nickel, or cobalt), in a helium atmosphere. The laser ablation method uses a laser to evaporate a graphite target that is usually filled with a catalyst metal powder. The arc discharge and laser ablation techniques tend to produce an ensemble of carbonaceous material which contain nanotubes (30-70%), amorphous carbon, and carbon particles (usually closed-caged ones). The nanotubes must then be extracted by some form of purification process before being manipulated into place for specific applications. The chemical vapour deposition process utilizes nanoparticles of metal catalyst to react with a hydrocarbon gas at temperatures of 500-900° C. A variant of this is plasma-enhanced chemical vapour deposition, by which vertically-aligned carbon nanotubes can easily be grown. In these chemical vapour deposition processes, the catalyst decomposes the hydrocarbon gas to produce carbon and hydrogen. The carbon dissolves into the particle and precipitates out from its circumference as the carbon nanotube. Thus, the catalyst acts as a ‘template’ from which the carbon nanotube is formed, and by controlling the catalyst size and reaction time, one can easily tailor the nanotube diameter and length respectively to suit. Carbon tubes, in contrast to a solid carbon filament, will tend to form when the catalyst particle is approximately 50 nm or less because if a filament of graphitic sheets were to form, it would contain an enormous percentage of ‘edge’ atoms in the structure. These edge atoms have dangling bonds that make the structure energetically unfavourable. The closed structure of tubular graphene shells is a stable, dangling-bond-free solution to this problem, and hence the carbon nanotube is the energetically favourable and stable structural form of carbon at these tiny dimensions. The set of linear oscillator mathematics, taken from Prof. U. Hartmann, describes atomic force gradient modified frequency in case of AC mode of frequency modulation (FM) operation of cantilever.

$$\frac{{\partial }^{2} d}{\partial {t}^{2}} + \frac{{ω}_{0}}{Q} \frac{\partial d}{\partial t} + {ω}_{0}^{2} ( d - {d}_{0} ) = {δ}_{0} {ω}_{0} cos ( ω t ) , \\ Q = \frac{m {ω}_{0}}{2 γ} , d ( t ) = {d}_{0} + δ cos ( ω t + α )$$

$$δ = \frac{{δ}_{0} {ω}_{0}^{2}}{\sqrt{{( {ω}^{2} - {ω}_{0}^{2} )}^{2} + 4 {γ}^{2} {ω}^{2}}}$$

$$α = arctan \frac{2 γω}{{ω}^{2} - {ω}_{0}^{2}}$$

$$F = F ( d , \frac{\partial d}{\partial t} ) {c}_{F} = c - \frac{\partial F}{\partial z} , ω = {ω}_{0} \sqrt{1 - \frac{1}{c} \frac{\partial F}{\partial z}}$$

$$Δω \approx - \frac{1}{2 c} \frac{\partial F}{\partial z}$$

$${( \frac{\partial F}{\partial z} )}_{min} = \frac{1}{{δ}_{rms}} \sqrt{\frac{2 kT β}{{ω}_{0} Q}} , τ = \frac{2 Q}{{ω}_{0}}$$

Thus, for a high-Q cantilever in vacuum (Q=50,000) and a typical resonant frequency of 50 kHz, the maximum available bandwidth would be only 0.5 Hz, which is unusable for most applications. The dynamic range of the system would be similarly restricted. Because of these restrictions, it is not useful to try to increase sensitivity by raising the Q to such high values. Moreover, if the experiments have to be performed in vacuum, for example, to prevent sample contamination, it might not be possible to obtain low enough Q for an acceptable bandwidth and dynamic range. Therefore, slope detection is unsuitable for most vacuum applications. An alternative to slope detection is frequency modulation (FM). In the FM detection system a high-Q cantilever vibrating on resonance serves as the frequency-determining component of an oscillator. Changes in δF/δz cause instantaneous changes in the oscillator frequency, which are detected by an FM demodulator. The cantilever is kept oscillating at its resonant frequency utilizing positive feedback. The vibration amplitude is likewise maintained at a constant level. A variety of methods, including those utilizing digital frequency counters and phase-locked loops, can be used to measure the oscillator frequency with a very high precision. In the case of FM detection, a careful analysis shows that, despite the minimum detectable force gradient, in contrast to slope detection, Q and b are absolutely independent in FM detection. Q depends only on the damping of the cantilever and b is set only by the characteristics of the FM demodulator. Therefore, the FM detection method allows the sensitivity to be greatly increased by using a very high Q without sacrificing bandwidth or dynamic range.

Not just the mere study of nature as it comes, but maneuvering things into paradoxical, unexpected and unusual states, with unprecedented properties, that do not exist anywhere else in the universe is a goal of nanoscience. This is science to the fullest—observations, understanding, prediction, and control. The nanophysics lab uses innovative experimental techniques to examine the physical properties of objects in the nanoscale size range, that is, a bit larger than the size of individual atoms. Some interesting physical properties that are measured include the electronic conductivity of small numbers of atoms and molecules, the forces arising between nanoscale objects, and the transition between the quantum behavior exhibited by a few atoms and the bulk properties of a large number of atoms. As described herein, a modified system is useful in surface physics diagnosis and for massive atomic storage over a crystal surface, which is then amenable to a parallel optical laser read out. In general, a direct and an inverse of AFM_NR multiple cantilevers can be designed also to be mechanically read out at room temperature for massive atomic-bit storage. Laser beam deflection offers a convenient and sensitive method of measuring cantilever deflection. AFMs can generally measure the vertical deflection of the cantilever with picometer resolution. To achieve this, most AFMs today use the optical lever, a device that achieves resolution comparable to an interferometer while remaining inexpensive and easy to use. As shown in FIG. 2, the optical lever operates by reflecting a laser beam off the cantilever. Angular deflection of the cantilever causes a twofold larger angular deflection of the laser beam. The reflected laser beam strikes a position-sensitive photodetector consisting of two side-by-side photodiodes. The difference between the two photodiode signals indicates the position of the laser spot on the detector and thus the angular deflection of the cantilever. Because the cantilever-to-detector distance generally measures thousands of times the length of the cantilever, the optical lever greatly magnifies motions of the tip. Because of this approximately 2000-fold magnification, optical lever detection can theoretically obtain a noise level of 10⁻¹⁴ m/Hz^{1/2}. For measuring cantilever deflection, to date only the relatively cumbersome techniques of interferometry and tunneling detection have approached this value. Micromachining techniques produce inexpensive, reasonably sharp tips.

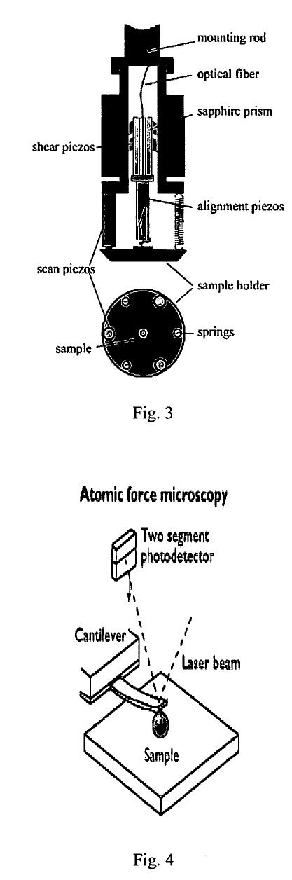

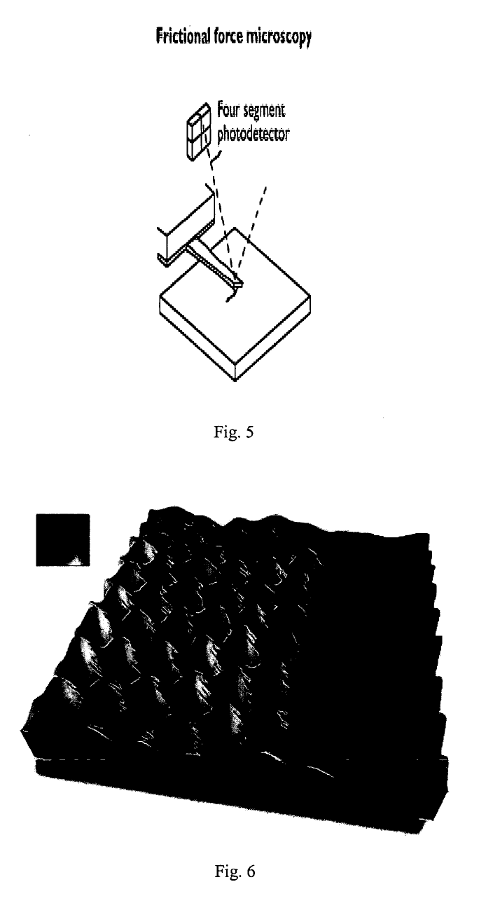

The earlier discussion of the way in which the bending of the cantilever is detected considered the use of a laser and a split photo-diode. Topographic imaging uses the up-and-down deflection of the cantilever to provide measurement data, as shown in FIG. 3. While AFM uses a two segment photodetector, as shown in FIG. 4, lateral force microscopy (LFM) uses a 4-segment (or quadrant) photo-diode to enable measurement of the torsion of the cantilever as well, as shown in FIG. 5. As the cantilever is scanned over the specimen surface (with the cantilever now scanning with its long axis perpendicular to the fast scan direction), variations in friction between the tip and sample will cause the tip to slick/slip during its scan, resulting in twisting of the cantilever. Chemical force microscopy combines LFM with treatments to the tip to customize its interaction with the sample.

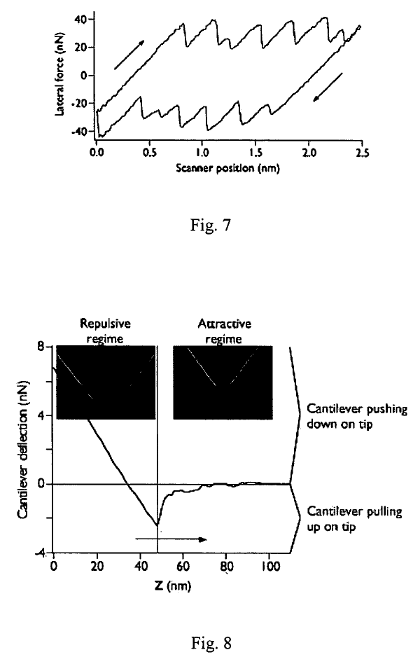

FIG. 6 shows a simultaneous friction and topography image of graphite atoms in which the topography image is plotted as a three-dimensional projection shaded by the friction data. Each bump represents one carbon atom. As the tip moves from right to left, it bumps into an atom and gets stuck behind it. The scanner continues to move and lateral force builds up until the tip slips past the atom and sticks behind the next one. This “stick-slip” behavior creates a characteristic sawtooth waveform in the friction image, as shown in FIG. 7.

AFMs can measure and image sample elasticity by pressing the tip into the sample and measuring the resulting cantilever deflection. The AFM can also image the softness of a sample by pressing the cantilever into it at each point in a scan. The scanner raises the sample or lowers the cantilever by a preset amount, the “modulation amplitude” (usually 1-10 nm). In response, the cantilever deflects an amount dependent on the softness of the sample: the harder the sample, the more the cantilever deflects.

When imaging in air, a layer of water condensation and other contamination covers both the tip and sample, forming a meniscus that pulls the two together. This meniscus force is an important influence on the tip-sample interaction force when imaging in air. At Z=0 nm, the cantilever pushes down on the tip, and tip and sample are in contact. As Z increases, the cantilever exerts less force and then begins to pull up on the tip (negative force). Eventually the cantilever exerts enough force to pull the tip free of the meniscus (2 nN for example). After this point, only attractive forces affect the cantilever deflection.

“Force curves” showing cantilever deflection as the scanner lowers the sample reveal the attractive meniscus force, as shown in FIG. 8. The cantilever has to exert an upward force to pull the tip free of the meniscus. This force equals the attractive force of the meniscus, usually 10-100 nN. The great strength of the meniscus makes it an important influence on the tip-sample interaction. Force microscopists often eliminate the meniscus by completely immersing both tip and sample in water.

Thus, the read/write device of the present invention, for Braille atomic storage at room temperature in open air, can provide diagnosis of crystal material and can directly measure the surface-atom interaction catalytic perturbation modified by Casimir mirror geometry of the zero-point vacuum fluctuation and the radiation induced dipole van der Waals long range attraction force between a neutral atomic bit and crystal lattice.

What is claimed is:

1. A process of providing storage for data on a storage medium, comprising:
precisely placing an atom onto a surface of the storage medium as an interstitial impurity; and
moving the atom to a specific storage site on the storage medium as a stored bit of data.

2. The process of claim 1, wherein the specific storage site represents an address on the surface of the storage medium.

3. The process of claim 1, wherein the storage medium is disposed in open air.

4. The process of claim 1, wherein the storage medium is disposed at room temperature.

5. The process of claim 1, wherein the atom has a size that is on the order of an angstrom.

6. The process of claim 1, wherein the stored atom represents a “1” data bit.

7. The process of claim 6, wherein at least one other specific storage site on the surface of the storage medium does not store an atom as an interstitial impurity and represents a “0” data bit.

8. The process of claim 1, wherein moving the atom to a specific storage site includes moving the atom by adaptive control.

9. The process of claim 8, wherein moving the atom by adaptive control includes moving the atom using a cantilever of an atomic force microscope.

10. The process of claim 9, wherein the cantilever is a single-crystal carbon nanotube tip.

11. The process of claim 9, wherein the atomic force microscope is used in contact mode operation.

12. The process of claim 9, wherein the cantilever is used to overcome a potential barrier at the specific storage site.

13. The process of claim 9, wherein the cantilever is used under computer feedback control.

14. The process of claim 1, wherein the surface of the storage medium has a regular lattice structure.

15. The process of claim 14, wherein the surface of the storage medium includes any one or more of a solid, plasma, and liquid crystal.

16. The process of claim 14, wherein the surface of the storage medium has a size ranging from about the order of a nariometer to about the order of a centimeter.

17. The process of claim 14, wherein the surface of the storage medium is arranged as a plurality of specific storage sites.

18. The process of claim 17, wherein the plurality of specific storage sites is arranged as an array.

19. The process of claim 17, wherein each of the plurality of specific storage sites is separated from an adjacent specific storage site by a distance on the order of ten angstroms.

20. The process of claim 14, wherein the storage medium is a body center crystal.

21. The process of claim 1, further comprising detecting the placed atom as a read operation.

22. The process of claim 21, utilizing an atomic force microscope to detect the placed atom.

23. A storage medium, comprising:
a surface;
an atom that is precisely inserted onto the surface as an interstitial impurity; and
a write device that moves the atom to a specific storage site on the surface as a stored bit of data.

24. The storage medium of claim 23, wherein the specific storage site represents an address on the surface.

25. The storage medium of claim 23, wherein the surface is disposed in open air.

26. The storage medium of claim 23, wherein the surface is disposed at room temperature.

27. The storage medium of claim 23, wherein the atom has a size that is on the order of an angstrom.

28. The storage medium of claim 23, wherein the stored atom represents a “1” data bit.

29. The storage medium of claim 28, wherein at least one other specific storage site on the surface does not store an atom as an interstitial impurity and represents a “0” data bit.

30. The storage medium of claim 23, wherein the write device moves the atom by adaptive control.

31. The storage medium of claim 30, wherein the write device includes a cantilever of an atomic force microscope.

32. The storage medium of claim 31, wherein the cantilever is a single-crystal carbon nanotube tip.

33. The storage medium of claim 31, wherein the atomic force microscope is set up for contact mode operation.

34. The storage medium of claim 31, wherein the cantilever provides force to overcome a potential barrier at the specific storage site.

35. The storage medium of claim 31, wherein the cantilever is adapted for communication with a computer for use under computer feedback control.

36. The storage medium of claim 23, wherein the surface has a regular lattice structure.

37. The storage medium of claim 36, wherein the surface includes any one or more of a solid, plasma, and liquid crystal.

38. The storage medium of claim 36, wherein the surface has a size ranging from about the order of a nanometer to about the order of a centimeter.

39. The storage medium of claim 36, wherein the surface is arranged as a plurality of specific storage sites.

40. The storage medium of claim 39, wherein the plurality of specific storage sites is arranged as an array.

41. The storage medium of claim 39, wherein each of the plurality of specific storage sites is separated from an adjacent specific storage site by a distance on the order of ten angstroms.

42. The storage medium of claim 36, wherein the surface includes a surface of a body center crystal.
